(19) United States
(12) Patent Application Publication
(10) Pub. No.: US 2018/0352980 A1
(43) Pub. Date: Dec. 13, 2018

(54) Textile with Cooling Technology Applied Thereto and Methods Thereof

(71) Applicant: Louis A. Casali, JR., New Canaan, CT (US)

(72) Inventor: Louis A. Casali, JR., New Canaan, CT (US)

(21) Appl. No.: 15/948,185

(22) Filed: Apr. 9, 2018

Related U.S. Application Data
(60) Provisional application No. 62/483,125, filed on Apr. 7, 2017.

(51) Int. Cl. A47G 9/10; D06M 13/02; D06M 23/12

(52) U.S. Cl. CPC A47G 9/1036; D06M 13/02; A01K 1/0353; D06B 2700/27; D06M 23/12

(57) ABSTRACT

A textile may have a cooling material which may contain a phase change material or other suitable materials or combinations thereof to be applied thereto. Such a material will thereby resisting an increase in temperature during use. The textile may be fashioned into a variety of objects including but not limited to pillows, mattresses, mattress toppers, etc. Further contained herein are methods of applying the cooling material and methods of making objects containing the cooling material.

### CLAIM OF PRIORITY

This application claims priority to U.S. Application 62/483,125 filed Apr. 7, 2017, which is herein filly incorporated by reference in its entirety.

### FIELD OF THE EMBODIMENTS

The field of the present invention and its embodiments relate textiles having a cooling material applied thereto. The cooling material preferably contains at least a phase change material thereby resisting an increase in temperature during use. Other suitable materials and combinations of materials may also be used. The textile may be fashioned into a variety of objects including but not limited to pillows, bedding, and the like.

### BACKGROUND OF THE EMBODIMENTS

Products having cooling technology applied thereto are effective at providing a cooling effect on a user of the products. Typically such a product is a pillow or bedding such as a mattress or mattress topper. However, known cooling layers are impermeable to air due to the nature of the cooling layer applied to the textile. As a result, air is not able to pass through the cooling layer(s), which thereby reduces the effectiveness of the layer. Further, such items (e.g. pillow) can act like a “balloon” and not let air be removed from the pillow thereby causing discomfort to a user.

Thus, there is a need for textile based products that impart a cooling effect to a user, but additionally have permeable surfaces that enable air flow therethrough. Review of related technology:

U.S. Patent Application 2016/0368185 pertains to a method of making a sleep product having a cooling gel layer includes providing a mold, coating the mold with a composite material including a mold release and a cooling gel, and introducing a foaming mixture into the mold so that the foaming mixture is in contact with the composite material. The foaming mixture is allowed to rise and cure into a foam layer having an outer surface covered by the composite material. The composite material is both a mold release coating that facilitates removing the foam layer from the mold and a cooling gel coating that remains on the outer surface of the foam layer after the foam layer has been removed from the mold to provide a cooling effect at the outer surface of the foam layer.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

Generally, the present invention and its embodiments provide for textile-based products having a cooling technology or chemistry applied thereto. Products containing such technology includes but is not limited to pillows, travel pillow, body pillows, mattress pads, mattress protectors, comforters, duvet covers, blankets, pet beds, furniture protectors, and the like. The cooling technology is based with a phase change material. The PCM based material or cooling material may be applied to any surface or material comprising the textile including the inner and outer surfaces and the fill. Preferably an inner surface is coated, in some fashion, with the cooling material. Other surface(s) may also be coated as desired. In a preferred embodiment, the cooling material is printed, coated, dyed, or otherwise applied onto the textile.

In one embodiment of the present invention there is a textile with a base layer having a length and a width; and a cooling material applied to a first surface of the base layer.

In one embodiment of the present invention there is a pillow with a first layer having a length and a width; a second layer having a length and a width, wherein the first layer is coupled to the second layer; and a phase change material applied to a first surface of the first layer and a first surface of the second layer, wherein the phase change material makes the first layer and the second layer substantially impermeable to air.

In one embodiment of the present invention there is a pillow with a first textile layer having a length and a width; a second textile layer having a length and a width; a phase change material applied to an inner surface of the first layer and an inner surface of the second layer, wherein the phase change material makes the first layer and the second layer substantially impermeable to air; and a gusset disposed between and couple to the first layer and the second layer, wherein the gusset is permeable to air, and wherein the gusset is substantially free of the phase change material.

In general, the present invention succeeds in conferring the following, and others not mentioned, benefits and objectives.

It is an object of the present invention to provide a textile having a cooling material disposed therein.

It is an object of the present invention to provide a textile having a phase change material applied thereto.

It is an object of the present invention to provide a textile with a phase change material in the form of a pillow.

It is an object of the present invention to provide a pillow having a gusset allowing for the exchange of air from inside the pillow and the external environment of the pillow.

It is an object of the present invention to provide a pillow that is cool to touch and comfortable to use.

### BRIEF DESCRIPTION OF THE DRAWINGS

FIG. 1 is a diagram illustrating a phase change shift of a phase change material.

FIG. 2 is a diagram of a screen printing methodology of applying an embodiment of the present invention.

FIG. 3 is a diagram of a first coating methodology of an embodiment of the present invention.

FIG. 4 is a diagram of a second coating methodology of an embodiment of the present invention.

FIG. 5 is a diagram of a third coating methodology of an embodiment of the present invention.

FIG. 6 is a diagram of a dyeing methodology of an embodiment of the present invention.

FIG. 7 is a prior art pillow design.

FIG. 8 is a pillow design of the present invention.

FIG. 9 shows a mattress pad of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

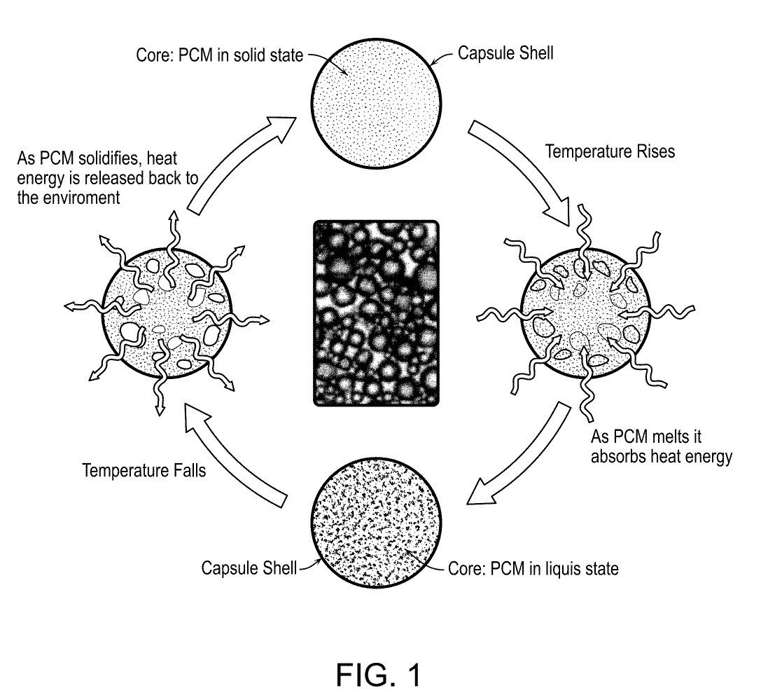

Referring now to FIG. 1, there is a diagram demonstrating a phase change material utilized in an embodiment of the present invention. The cooling chemistry or phase change material comprises a microencapsulated phase change material (PCM) in any form such as but not limited to a slurry, wet cake, and/or dry powder or combinations thereof. The microencapsulated PCM may comprise at least one of the following components and/or properties: organic center types of PCM, paraffin, fatty acids and/or polyglycols, inorganic or bio-based centers, formaldehyde, acrylic, or any hybrid shell. The PCM may further be inclusive of any available or customized melting point (e.g. 24° C., 28° C., 32° C., 37° C., 43° C., 58° C. and 65° C.).

The application of the cooling chemistry can applied onto any type of textile substrate. The add-on of the cooling chemistry can be from 0.01 oz/sq. yd. to 100 oz/sq. yd. dry weight. The applied solution can be from 1% to 100% cooling chemistry. Inactives comprising the cooling chemistry may comprise water, hydrocarbons or other materials capable of having the PCM suspended therein. The cooling chemistry may be applied evenly over a particular surface or may comprise various patterns or configurations on the textile material.

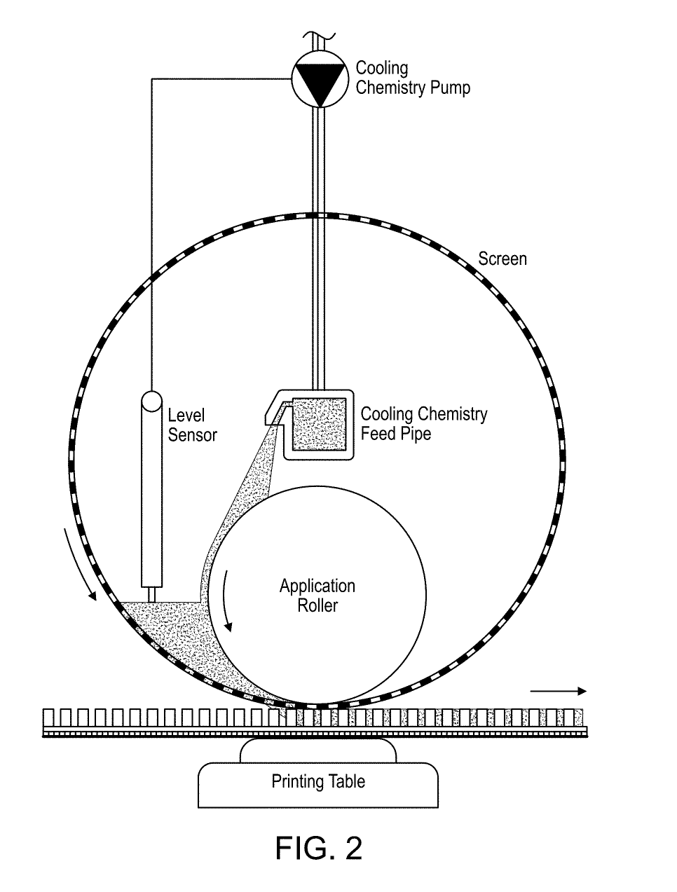

Referring now to FIG. 2, there is a diagram showing a screen printing methodology of the present invention such as a rotary, flat or hand printing, or automatic screen printing press. The process of applying the cooling chemistry to the textile through a screen involves a blade that squeezes the cooling technology through openings in the screen onto the fabric or textile. The openings can be continuous over the confines of the screen or could create a design and/or pattern. The mesh used to apply the cooling chemistry includes any available size mesh from 40 to a Galvano screen. In some embodiments, multiple coatings may be required to fully complete the application of the cooling chemistry to the textile.

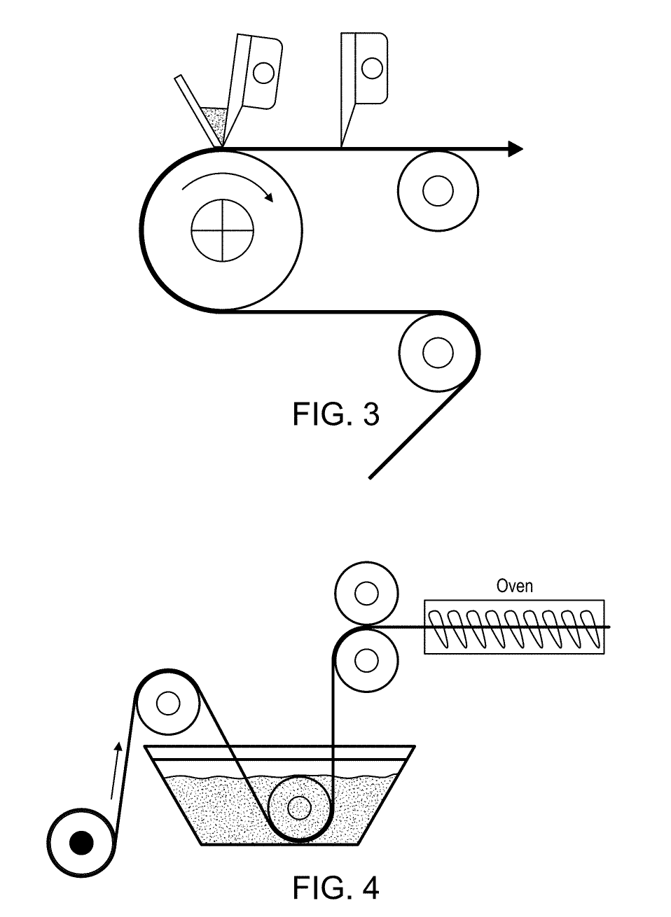

Referring now to FIG. 3, there is a knife over roller coating methodology. The cooling chemistry is being applied to the textile which then passes through a “gap” between a “knife” and a support roller. As the coated cooling chemistry and the substrate pass through, the excess is scraped off leaving behind the cooling chemistry to dry on the textile.

Referring now to FIG. 4, there is a dip coating methodology illustrated. In this process, the textile is dipped into a bath of the cooling chemistry coating, passed through squeeze rollers to control the cooling chemistry coating thickness or add on, then carried through a series of ovens (either horizontally or vertically) for drying and curing.

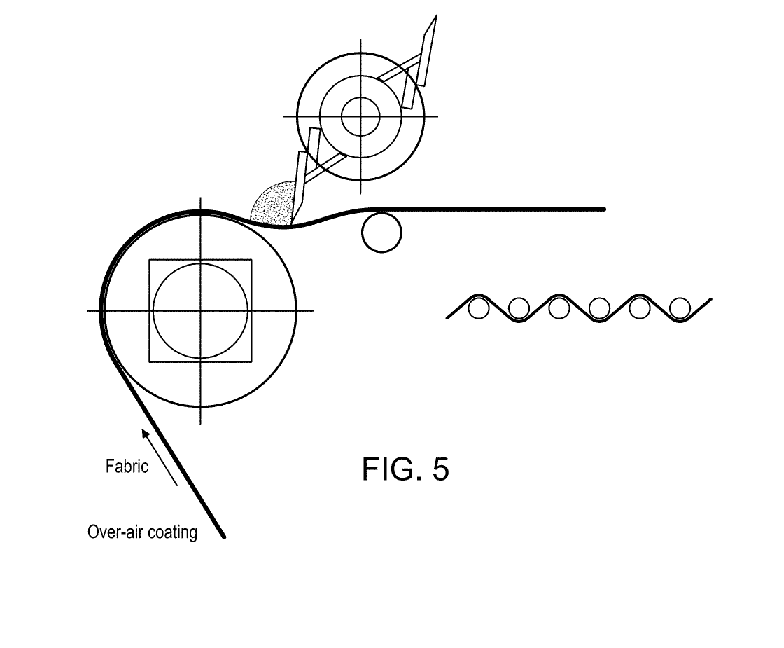

Referring now to FIG. 5, there is an air knife coating methodology. This is a relatively simple process where the cooling chemistry coating is applied to the substrate and the excess is “blown off” by a powerful jet from the air knife with the remaining cooling chemistry being allowed to dry.

Other coating methodologies may include but are not limited to gravure coating, reverse roll coating, metering rod coating, and slot die coating. The gravure coating process relies on an engraved roller running in a coating bath, which fills the engraved dots or lines of the roller with the cooling chemistry coating material. The excess coating on the roller is wiped off by the Doctor Blade and the coating is then deposited onto the substrate as it passes between the Engraved roller and a Pressure Roller. In reverse roll coating, the cooling chemistry coating material is measured onto the applicator roller by precision setting of the gap between the upper metering roller and the application roller below it. The coating is “wiped” off the application roller by the substrate as it passes around the support roller at the bottom. In metering rod coating, an excess of the cooling chemistry coating is deposited onto the substrate as it passes over the bath roller. The wire-wound metering rod, sometimes known as a Meyer Rod, allows the desired quantity of the coating to remain on the substrate. The quantity is determined by the diameter of the wire used on the rod. In the slot die process, the cooling chemistry coating is squeezed out by gravity or under pressure through a slot and onto the substrate.

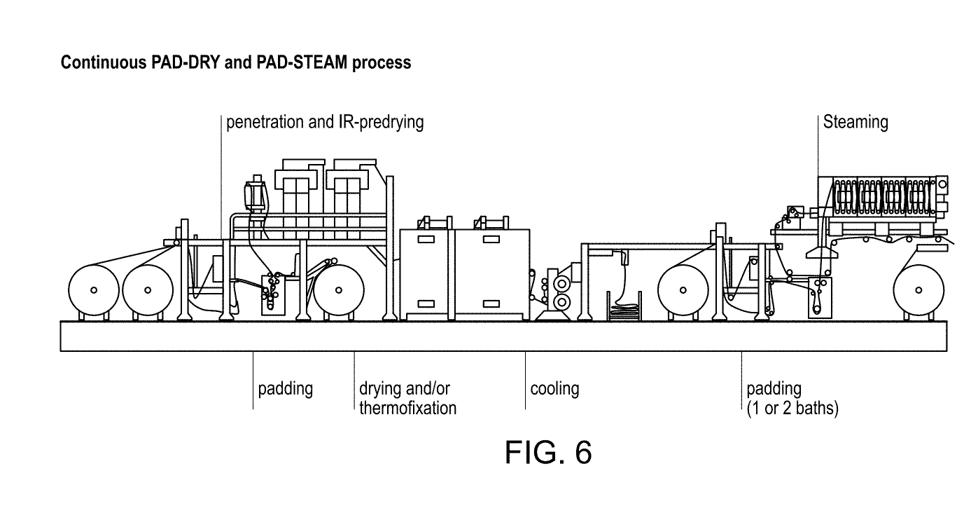

Referring now to FIG. 6, there is a dyeing methodology shown. The technique or process used in pad-batch dyeing starts with saturating first the prepared fabric with pre-mixed cooling chemistry. Then it is passed through rollers. The rollers, or padders, effectively forces the cooling chemistry into the fabric. In the process, excess cooling chemistry is also removed.

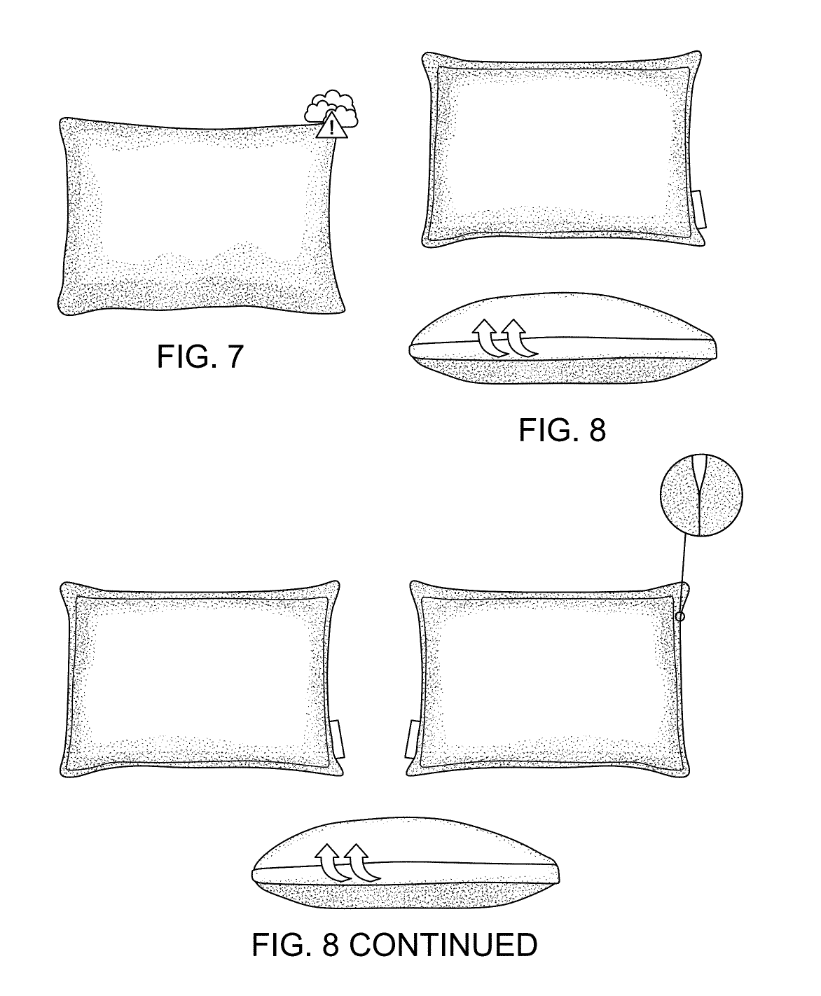

FIG. 7 illustrates a prior art pillow which exhibits breathability issues. Here, the pillow is formed of a first face and a second face. The first face is directly affixed to the second face via stitching. As a result, there is limited, if any, exchange of air from inside of the pillow to the outside of the pillow. The result is a pillow that does not provide adequate temperature regulation to a user and is uncomfortable to use.

FIG. 8 illustrates a pillow of the present invention where the gussets allow for breathability and enhanced performance of the pillow. Here, the top and bottom fabrics are a textile treated with cooling chemistry. The side of the top and bottom fabrics comprising the cooling chemistry could be inside or outside (inner surface or outer surface) of the pillow. The cooling chemistry may be applied by any of the above described methodologies or another methodology not explicitly described herein.

The pillow, as shown in FIG. 8, further comprises an untreated textile gusset on all (four) sides of the pillow. That is, a gusset that does not contain the cooling chemistry treatment as described herein. In some embodiments, the gusset may be on less than all sides of the pillow. In other embodiments, the pillow has more or less than four sides with the gusset being on all sides or less than all sides of the pillow.

This gusset can have a height size from 0.01 in to 10 in or more depending on the pillow size and the desired amount of air exchange between an interior of the pillow and an environment of the pillow. Preferably, as stated above, the gusset is disposed around an entire periphery of the pillow. With most textiles that may be used in implementations of the present invention, the cooling chemistry creates an unbreathable layering or coating, preventing the pillow the proper breathability. Thus, the gusset construction described herein allows the proper breathability on all sides of the pillow. The gusset can be made of any type of substrate, in any color or pattern. The pillows can be filled with any type of fill. The pillow is then closed shut and is ready for use.

Further embodiments of the present invention may include but are not limited to pillow covers or pillow protectors, mattress pads and protectors, comforters, duvet covers, blankets, pet beds, furniture covers, etc.

A pillow cover is typically any cover used to protect any type and size of bed sleeping pillow, body pillows and travel pillows. In accordance with the present invention, the pillow covers comprise a top and a bottom fabric comprising a textile treated with the cooling chemistry. The treated side of the textile with the cooling chemistry may be an inner surface, an outer surface, or a combination thereof of the pillow cover or protector. Further, the pillow protector preferably has an untreated textile gusset on all sides of the pillow cover or protector. This gusset have a height from 0.01 in to 10 in or more.

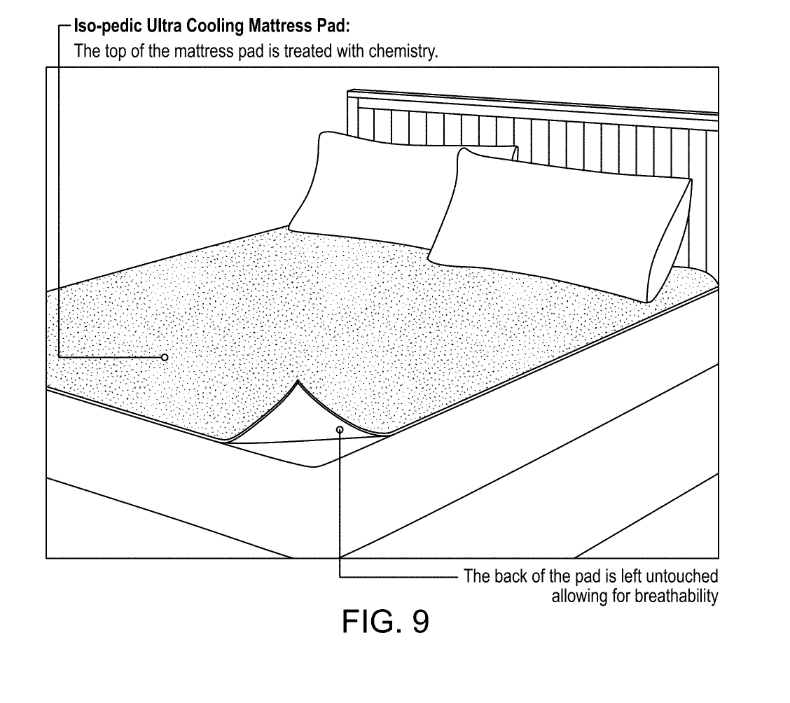

Mattress pads, as shown in FIG. 9, a covering that goes under a sheet on a bed to protect the mattress. It can be single or multi layers. The top layer has the cooling chemistry application on either or both sides of the textile. It can be quilted or not. Can have a skirt that goes around the platform of the mattress or anchor bands that holds it in place on four corners.

A comforter is a thick, quilted, fluffy blanket that is used to keep you warm. It is usually filled with synthetic fiber filler which is quilted or stitched to secure the filling and keep it evenly distributed. The cooling chemistry can be used on the back side of the comforter.

A duvet cover comprises fabrics sewn together creating a protector or cover for a comforter or duvet with any style of closure.

A blanket can be a single layer of a textile or a triple layer, etc. On a single layer, the cooling chemistry is applied to one side of the textile. The triple layer blanket consists of a face and back textile with a natural or synthetic inner layer. All three layers are quilted together. In this case, the cooling chemistry can be applied to one side or both sides of the blanket.

A pet bed is a bed designed for a pet. It can be single or multi layered using any type of substrate or design. The layer that is in contact with the pet will have the cooling chemistry applied to either or both sides of the substrate.

Furniture protectors comprise a single or multi-layer cover to protect any style/type of furniture. The top layer of the protector will have the cooling chemistry application on both or either side.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A textile comprising:
a base layer having a length and a width; and
a cooling material applied to a first surface of the base layer.

2. The textile of claim 1 wherein the cooling material is a phase change material.

3. The textile of claim 1 wherein the textile is a pillow and the first surface is an inner surface of the pillow.

4. The textile of claim 1 wherein the textile is a pillow and the first surface is an outer surface of the pillow.

5. The textile of claim 3 wherein the pillow further comprises gussets along a side surface of the pillow,
wherein both an inner surface and outer surface of the gussets are substantially free of the cooling material.

6. A pillow comprising:
a first layer having a length and a width;
a second layer having a length and a width,
wherein the first layer is coupled to the second layer; and
a phase change material applied to a first surface of the first layer and a first surface of the second layer,
wherein the phase change material makes the first layer and the second layer substantially impermeable to air.

7. The pillow of claim 6 further comprising a gusset,
wherein the gusset is permeable to air and is coupled to each of the first layer and the second layer.

8. The pillow of claim 7 wherein the gusset is disposed around an entire periphery of the pillow.

9. The pillow of claim 6 wherein the first surface of the first layer is an inner surface of the first layer and the first surface of the second layer is an inner surface of the second layer.

10. The pillow of claim 6 wherein the first surface of the first layer is an inner surface of the first layer and the first surface of the second layer is an outer surface of the second layer.

11. The pillow of claim 6 wherein the first surface of the first layer is an outer surface of the first layer and the first surface of the second layer is an inner surface of the second layer.

12. The pillow of claim 6 wherein the first surface of the first layer is an outer surface of the first layer and the first surface of the second layer is an outer surface of the second layer.

13. The pillow of claim 6 wherein the phase change material is applied to the first surface and a second surface of the first layer.

14. The pillow of claim 6 wherein the phase change material is applied to the first surface and a second surface of the second layer.

15. The pillow of claim 6 wherein the phase change material is paraffin.

16. A pillow comprising:
a first textile layer having a length and a width;
a second textile layer having a length and a width;
a phase change material applied to an inner surface of the first layer and an inner surface of the second layer,
wherein the phase change material makes the first layer and the second layer substantially impermeable to air; and
a gusset disposed between and couple to the first layer and the second layer,
wherein the gusset is permeable to air, and
wherein the gusset is substantially free of the phase change material.
